(19) United States
(12) Patent Application Publication
(10) Pub. No.: US 2013/0148696 A1
(43) Pub. Date: Jun. 13, 2013

(54) SATELLITE BROADCASTING SYSTEM AND METHOD

(71) Applicant: Electronics and Telecommunications Research Institute, Daejeon (KR)

(72) Inventors: Joon Gyu RYU, Daejeon (KR); Deock Gil OH, Daejeon (KR)

(73) Assignee: Electronics and Telecommunications Research Institute, Daejeon (KR)

(21) Appl. No.: 13/711,538

(22) Filed: Dec. 11, 2012

(30) Foreign Application Priority Data
Dec. 12, 2011 (KR) 10-2011-0132542

(51) Int. Cl. H04B 1/707

(52) U.S. Cl. CPC H04B 1/707
USPC 375/146; 375/147

(57) ABSTRACT

Provided is a satellite broadcasting system and method using a spread spectrum technique to improve satellite broadcasting availability in a rainy environment and to provide a satellite broadcasting N-screen service. A satellite broadcasting transmitter of the satellite broadcasting system may encode a broadcast signal into each of a high definition (HD) signal, a standard definition (SD) signal, and a low definition (LD) signal, may modulate each of the encoded HD signal and the encoded SD signal by a predetermined modulation scheme, may spread a spectrum of the encoded LD signal to generate a spread spectrum signal, may to modulate the spread spectrum signal, may combine the modulated spread spectrum signal with the modulated HD signal and the modulated SD signal to generate a combined modulated signal, and may transmit the combined modulated signal to a satellite.

### CROSS-REFERENCE TO RELATED APPLICATION

This application claims the priority benefit of Korean Patent Application No. 10-2011-0132542, filed on Dec. 12, 2011, in the Korean Intellectual Property Office, the disclosure of which is incorporated herein by reference.

### BACKGROUND

1. Field of the Invention

The present invention relates to a satellite broadcasting system and method using a spread spectrum technique to improve the availability satellite broadcasting and to provide a satellite broadcasting N-screen service in a rainy environment.

2. Description of the Related Art

Generally, a technology for adjusting an effective isotropically radiated power (EIRP) of a satellite transponder variably is used to provide a stable satellite broadcasting service in a rainy environment.

To overcome an effect of rain attenuation through a transmission technology of a satellite broadcasting system, variable coding and modulation (VCM) is suggested. The VCM includes variable modulation and coding (MODCOD) in a physical layer and scalable video coding (SVC).

Conventionally, according to VCM, a high definition (HD) image is transmitted at a high modulation and coding rate, for example, by 8 phase shift keying (8PSK) and rate-¾ low-density parity-check (LDPC ¾), and a standard definition (SD) image is transmitted at a low modulation and coding rate, for example, by quadrature phase shift keying (QPSK) and LDPC ½ so that the SD image may be received in a rainy environment. However, when an amount of rainfall increases, the conventional VCM fails to receive an SD image, and a transmission bandwidth needs to be increased for an additional layer.

### SUMMARY

An aspect of the present invention provides a satellite broadcasting system and method.

Another aspect of the present invention also provides a transmission technology for providing a satellite broadcasting service of a minimum resolution seamlessly in a rainy environment, and a technology for providing an N-screen service in a satellite broadcasting to environment to use a satellite broadcasting service on a mobile communication terminal.

According to an aspect of the present invention, there is provided a transmitter of a satellite broadcasting system including a first encoder to encode a broadcast signal into a high definition (HD) signal, a second encoder to encode the broadcast signal into a standard definition (SD) signal, a third encoder to encode the broadcast signal into a low definition (LD) signal, a modulator to modulate each of the encoded HD signal and the encoded SD signal by a predetermined modulation scheme, a spreader to spread a spectrum of the encoded LD signal to generate a spread spectrum signal, and to modulate the generated spread spectrum signal, and a multiplexer to combine the modulated spread spectrum signal with the modulated HD signal and the modulated SD signal to generate a combined modulated signal.

According to another aspect of the present invention, there is provided a receiver of a satellite broadcasting system including a demodulator to demodulate a satellite signal to extract an encoded HD signal and an encoded SD signal, a first error analyzer to analyze an error in each of the encoded HD signal and the encoded SD signal, a despreader to despread and demodulate the satellite signal to extract an encoded LD signal, a second error analyzer to analyze an error in the encoded LD signal, a selector to select a signal having a highest displayable definition by identifying the error in each of the encoded HD signal, the encoded SD signal, and the encoded LD signal, and a decoder to decode the signal selected by the selector.

According to still another aspect of the present invention, there is provided a receiver of a satellite broadcasting system including a demodulator to demodulate a satellite signal to extract an encoded HD signal and an encoded SD signal, an error analyzer to analyze an error in each of the encoded HD signal and the encoded SD signal, a selector to select a signal having a highest displayable definition by identifying the error in each of the encoded HD signal and the encoded SD signal, a decoder to decode the signal selected by the selector, a to despreader to despread and demodulate the satellite signal to extract an encoded LD signal, and a packetizer to packetize the encoded LD signal into Internet Protocol (IP) packets and to output the IP packets to an IP network.

According to yet another aspect of the present invention, there is provided a method of transmitting satellite broadcasts in a satellite broadcasting system, the method including encoding a broadcast signal into an HD signal, encoding the broadcast signal into an SD signal, encoding the broadcast signal into an LD signal, modulating each of the encoded HD signal and the encoded SD signal by a predetermined modulation scheme, spreading a spectrum of the encoded LD signal to generate a spread spectrum signal and modulating the generated spread spectrum signal, and combining the modulated spread spectrum signal with the modulated HD signal and the modulated SD signal to generate a combined modulated signal.

According to further another aspect of the present invention, there is provided a method of receiving satellite broadcasts in a satellite broadcasting system, the method including demodulating a satellite signal to extract an encoded HD signal and an encoded SD signal, despreading and demodulating the satellite signal to extract an encoded LD signal, analyzing an error in each of the encoded HD signal, the encoded SD signal, and the encoded LD signal, selecting a signal having the highest displayable definition by identifying the error in each of the encoded HD signal, the encoded SD signal, and the encoded LD signal, and decoding the selected signal having the highest displayable definition.

According to another aspect of the present invention, there is provided a method of receiving satellite broadcasts in a satellite broadcasting system, the method including demodulating a satellite signal to extract an encoded HD signal and an encoded SD signal, analyzing an error in each of the encoded HD signal and the encoded SD signal, selecting a signal having the highest displayable definition by identifying the error in each of the encoded HD signal and the encoded SD signal, decoding the selected signal having the to highest displayable definition, despreading and demodulating the satellite signal to extract an encoded LD signal, and packetizing the encoded LD signal into Internet Protocol (IP) packets and outputting the IP packets to an IP network.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a configuration of a satellite broadcasting transmitter using a spread spectrum technique according to an embodiment of the present invention;

FIG. 2 is a diagram illustrating a configuration of a satellite broadcasting receiver using a spread spectrum technique according to an embodiment of the present invention;

FIG. 3 is a diagram illustrating a configuration of a satellite broadcasting receiver for providing an N-screen service using a spread spectrum technique according to an embodiment of the present invention;

FIG. 4 is a flowchart illustrating a process of transmitting satellite broadcasts in a satellite broadcasting transmitter according to an embodiment of the present invention;

FIG. 5 is a flowchart illustrating a process of receiving satellite broadcasts in a satellite broadcasting receiver according to an embodiment of the present invention; and

FIG. 6 is a flowchart illustrating a process of receiving satellite broadcasts in a satellite broadcasting receiver according to another embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are to described below to explain the present invention by referring to the figures.

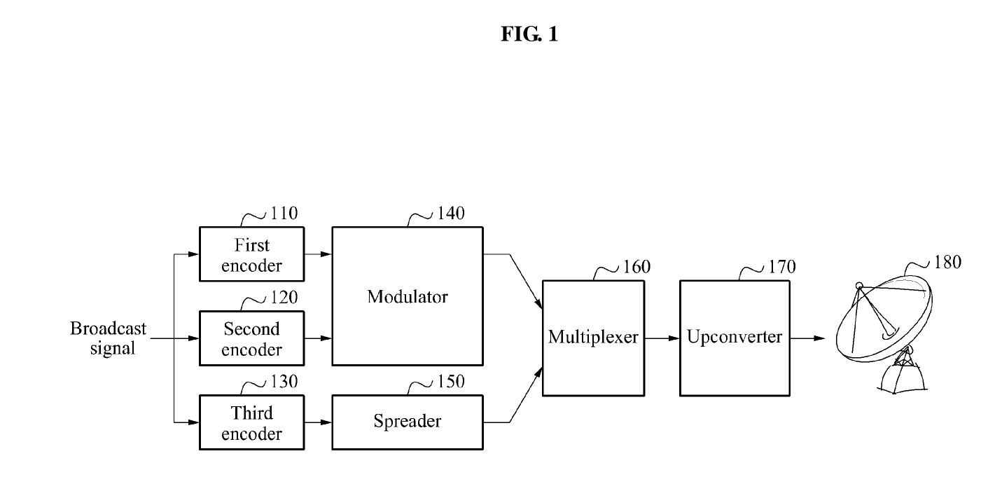

FIG. 1 is a diagram illustrating a configuration of a satellite broadcasting transmitter using a spread spectrum technique according to an embodiment of the present invention.

Referring to FIG. 1, the satellite broadcasting transmitter may include a first encoder 110, a second encoder 120, a third encoder 130, a modulator 140, a spreader 150, a multiplexer 160, an upconverter 170, and a satellite antenna 180.

The first encoder 110 may encode a broadcast signal into a high definition (HD) signal. In this instance, the HD signal may correspond to a signal having high-level definition.

The second encoder 120 may encode the broadcast signal into a standard definition (SD) signal. In this instance, the SD signal may correspond to a signal having standard-level definition.

The third encoder 130 may encode the broadcast signal into a low definition (LD) signal. In this instance, the LD corresponds to ¼ a value of the SD value.

The modulator 140 may modulate each of the encoded HD signal and the encoded SD signal by a predetermined modulation scheme. In this instance, the modulator 140 may modulate the encoded HD signal by 8 phase shift keying (8PSK) and rate-¾ low-density parity-check (LDPC ¾), and may modulate the encoded SD signal by quadrature phase shift keying (QPSK) and LDPC ½.

The modulator 140 may output the modulated HD signal and the modulated SD signal to the multiplexer 160 in an alternate manner.

The spreader 150 may spread a spectrum of the encoded LD signal to generate a spread spectrum signal, and may modulate the generated spread spectrum signal

The multiplexer 160 may combine the modulated spread spectrum signal with the modulated HD signal and the modulated SD signal to generate a combined modulated signal. That is, the multiplexer 160 may combine the modulated spread spectrum signal with the modulated HD signal and the modulated SD signal received from the modulator 140 in an alternating manner.

The upconverter 170 may upconvert a frequency of the combined modulated signal outputted from the multiplexer 160.

The satellite antenna 180 may transmit the frequency-upconverted combined modulated signal to a satellite.

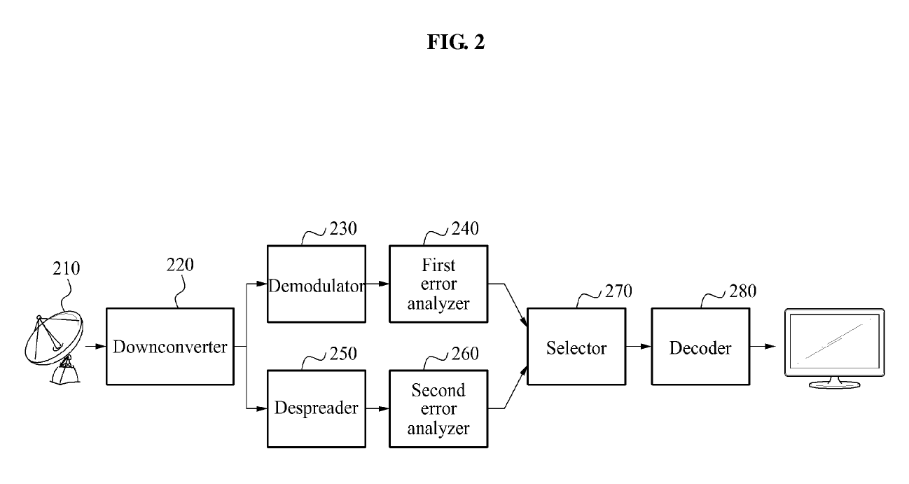

FIG. 2 is a diagram illustrating a configuration of a satellite broadcasting receiver using a spread spectrum technique according to an embodiment of the present invention.

Referring to FIG. 2, the satellite broadcasting receiver may include a satellite antenna 210, a downconverter 220, a demodulator 230, a first error analyzer 240, a despreader 250, a second error analyzer 260, a selector 270, and a decoder 280.

The demodulator 230 may demodulate a satellite signal received through the satellite antenna 210 and frequency-downconverted through the downconverter 220, to extract an encoded HD signal and an encoded SD signal.

The first error analyzer 240 may analyze an error in each of the encoded HD signal and the encoded SD signal.

The despreader 250 may despread and demodulate the satellite signal received through the satellite antenna 210 and frequency-downconverted through the downconverter 220, to extract an encoded LD signal.

The second error analyzer 250 may analyze an error in the encoded LD signal.

The selector 270 may select a signal having a highest displayable definition by identifying the error in each of the encoded HD signal, the encoded SD signal, and the encoded LD signal.

The decoder 280 may decode the signal selected by the selector 270.

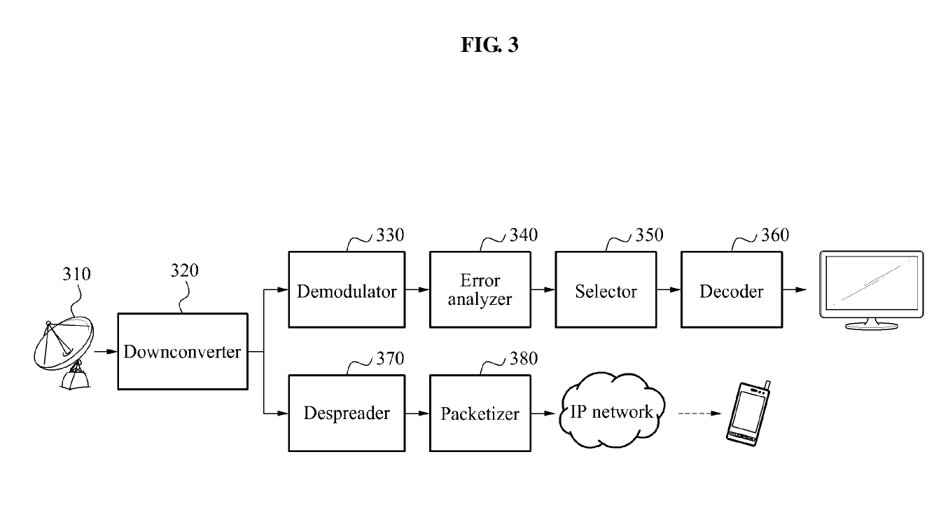

FIG. 3 is a diagram illustrating a configuration of a satellite broadcasting receiver for providing an N-screen service using a spread spectrum technique according to an embodiment of the present invention.

Referring to FIG. 3, the satellite broadcasting receiver may include a satellite antenna 310, a downconverter 320, a demodulator 330, an error analyzer 340, a selector 350, a decoder 360, a despreader 370, and a packetizer 380.

The demodulator 330 may demodulate a satellite signal received through the satellite antenna 310 and frequency-downconverted through the downconverter 320, to extract an encoded HD signal and an encoded SD signal.

The error analyzer 340 may analyze an error in each of the encoded HD signal and the encoded SD signal.

The selector 350 may select a signal having a highest displayable definition by identifying the error in each of the encoded HD signal and the encoded SD signal.

The decoder 360 may decode the signal selected by the selector 350.

The despreader 370 may despread and demodulate the satellite signal received through the satellite antenna 310 and frequency-downconverted through the downconverter 320, to extract an encoded LD signal.

The packetizer 380 may packetize the encoded LD signal into Internet Protocol (IP) packets, and may output the IP packets to an IP network to provide an N-screen service.

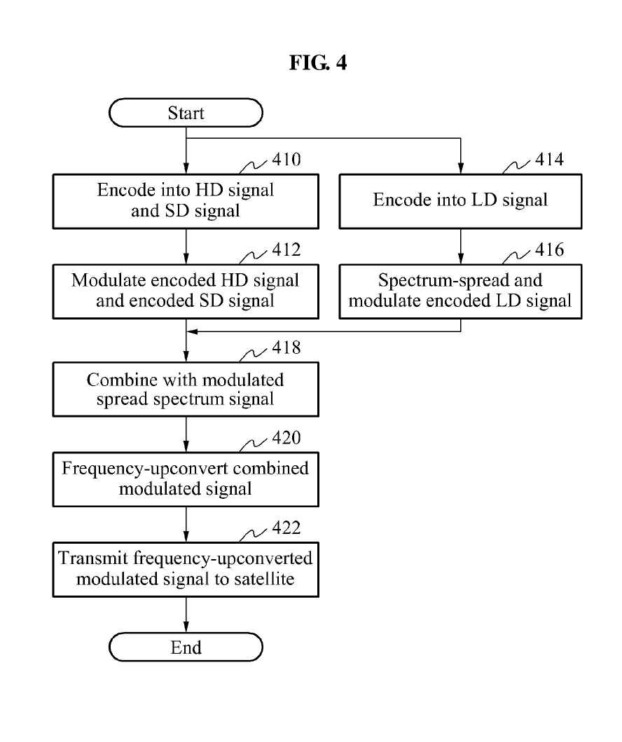

Hereinafter, a method of transmitting and receiving a spread spectrum broadcast signal through a satellite in the satellite broadcasting system according to an embodiment of the present invention is described with reference to FIGS. 4 through 6.

FIG. 4 is a flowchart illustrating a process of transmitting satellite broadcasts in the satellite broadcasting transmitter according to an embodiment of the present invention.

Referring to FIG. 4, in operation 410, the satellite broadcasting transmitter may encode a broadcast signal into each of an HD signal and an SD signal.

In operation 412, the satellite broadcasting transmitter may modulate each of the encoded HD signal and the encoded SD signal by a predetermined modulation scheme.

In operation 414, the satellite broadcasting transmitter may encode the broadcast signal into an LD signal.

In operation 416, the satellite broadcasting transmitter may spread a spectrum of the encoded LD signal to generate a spread spectrum signal, and may modulate the generated spread spectrum signal.

In operation 418, the satellite broadcasting transmitter may combine the modulated spread spectrum signal with the modulated HD signal and the modulated SD signal to generate a combined modulated signal.

In operation 420, the satellite broadcasting transmitter may upconvert a frequency of the combined modulated signal.

In operation 422, the satellite broadcasting transmitter may transmit the frequency-upconverted modulated signal to the satellite.

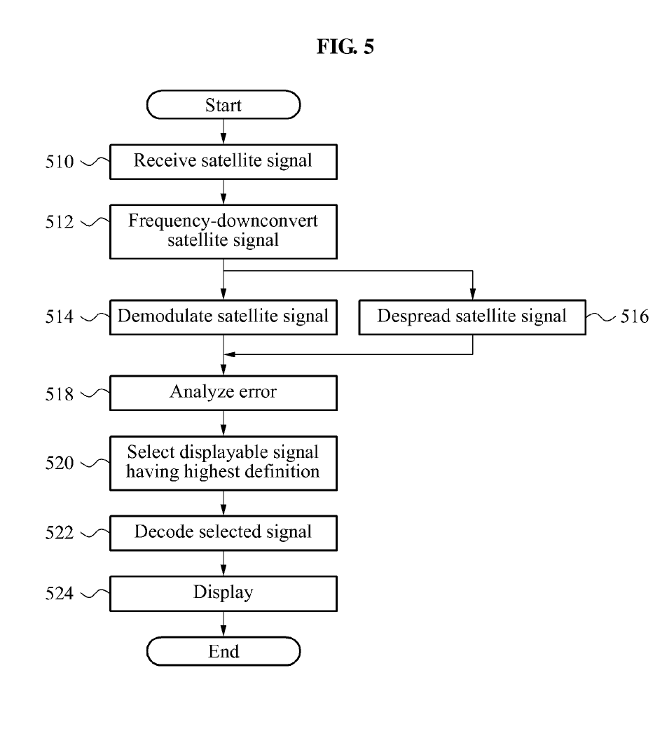

FIG. 5 is a flowchart illustrating a process of receiving satellite broadcasts in the satellite broadcasting receiver according to an embodiment of the present invention.

Referring to FIG. 5, in operation 510, the satellite broadcasting receiver may receive a satellite signal.

In operation 512, the satellite broadcasting receiver may downconvert a frequency of the received satellite signal.

In operation 514, the satellite broadcasting receiver may demodulate the frequency-downconverted satellite signal to extract an encoded HD signal and an encoded SD signal.

In operation 516, the satellite broadcasting receiver may despread and demodulate the frequency-downconverted satellite signal to extract an encoded LD signal.

In operation 518, the satellite broadcasting receiver may analyze an error in each of the encoded HD signal, the encoded SD signal, and the encoded LD signal.

In operation 520, the satellite broadcasting receiver may select a signal having a highest displayable definition by identifying the error in each of the encoded HD signal, the encoded SD signal, and the encoded LD signal.

In operation 522, the satellite broadcasting receiver may decode the selected signal having the highest displayable definition.

In operation 524, the satellite broadcasting receiver may display the decoded signal.

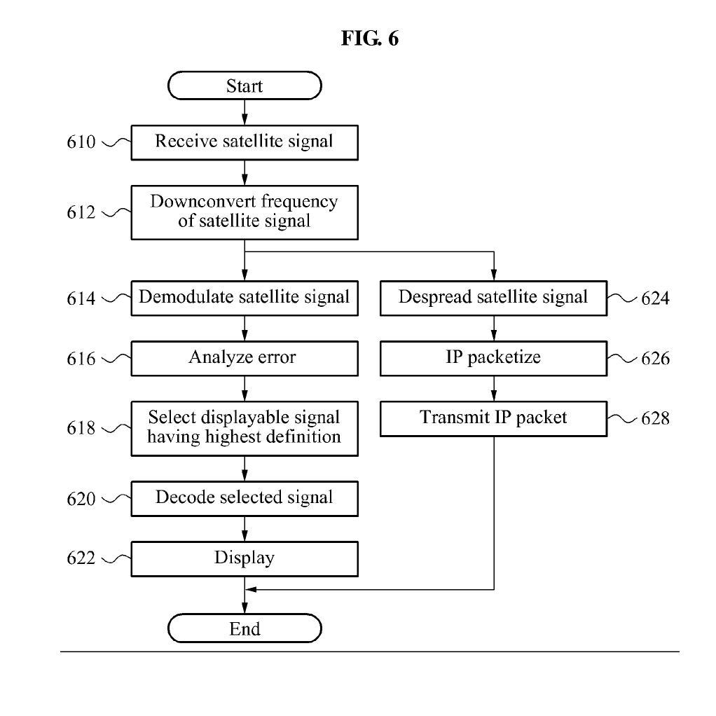

FIG. 6 is a flowchart illustrating a process of receiving satellite broadcasts in the satellite broadcasting receiver according to another embodiment of the present invention.

Referring to FIG. 6, in operation 610, the satellite broadcasting receiver may receive a satellite signal.

In operation 612, the satellite broadcasting receiver may downconvert a frequency of the received satellite signal.

In operation 614, the satellite broadcasting receiver may demodulate the frequency-downconverted satellite signal to extract an encoded HD signal and an encoded SD signal.

In operation 616, the satellite broadcasting receiver may analyze an error in each of the encoded HD signal and the encoded SD signal.

In operation 618, the satellite broadcasting receiver may select a signal having a highest displayable definition by identifying the error in each of the encoded HD signal and the encoded SD signal.

In operation 620, the satellite broadcasting receiver may decode the selected signal having the highest displayable definition.

In operation 622, the satellite broadcasting receiver may display the decoded signal.

In operation 624, the satellite broadcasting receiver may despread and demodulate the frequency-downconverted satellite signal to extract an encoded LD signal.

In operation 626, the satellite broadcasting receiver may packetize the encoded LD signal into IP packets.

In operation 628, the satellite broadcasting receiver may output the IP packets to an IP network.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

The present invention may improve a reception performance greatly in a rainy environment by transmitting an LH signal using a spread spectrum technique based on variable coding and modulation (VCM). Also, the present invention may provide an N-screen service in a rainy environment absent additional bandwidth allocation.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A transmitter of a satellite broadcasting system comprising:
a first encoder to encode a broadcast signal into a high definition (HD) signal;
a second encoder to encode the broadcast signal into a standard definition (SD) signal;
a third encoder to encode the broadcast signal into a low definition (LD) signal;
a modulator to modulate each of the encoded HD signal and the encoded SD signal by a predetermined modulation scheme;
a spreader to spread a spectrum of the encoded LD signal to generate a spread spectrum signal, and to modulate the generated spread spectrum signal; and
a multiplexer to combine the modulated spread spectrum signal with the modulated HD signal and the modulated SD signal to generate a combined modulated signal.

2. The transmitter of claim 1, wherein the HD corresponds to a high-level definition, the SD corresponds to a standard-level definition, and the LD corresponds to ¼ a value of the SD value.

3. The transmitter of claim 1, wherein the modulator outputs the modulated HD signal and the modulated SD signal to the multiplexer in an alternate manner, and
the multiplexer combines the modulated spread spectrum signal with the modulated HD signal and the modulated SD signal received in an alternate manner.

4. The transmitter of claim 1, further comprising:
an upconverter to upconvert a frequency of the combined modulated signal; and
a satellite antenna to transmit the frequency-upconverted combined modulated signal to a satellite.

5. A receiver of a satellite broadcasting system comprising:
a demodulator to demodulate a satellite signal to extract an encoded high-definition (HD) signal and an encoded standard definition (SD) signal;
a first error analyzer to analyze an error in each of the encoded HD signal and the encoded SD signal;
a despreader to despread and demodulate the satellite signal to extract an encoded low definition (LD) signal;
a second error analyzer to analyze an error in the encoded LD signal;
a selector to select a signal having a highest displayable definition by identifying the error in each of the encoded HD signal, the encoded SD signal, and the encoded LD signal; and
a decoder to decode the signal selected by the selector.

6. The receiver of claim 5, wherein the HD corresponds to a high-level definition, the SD corresponds to a standard-level definition, and the LD corresponds to ¼ a value of the SD value.

7. The receiver of claim 5, further comprising:
a satellite antenna to receive the satellite signal; and
a downconverter to downconvert a frequency of the satellite signal and to provide the frequency-downconverted satellite signal to the demodulator and the despreader.

8. A receiver of a satellite broadcasting system comprising:
a demodulator to demodulate a satellite signal to extract an encoded high definition (HD) signal and an encoded standard definition (SD) signal;
an error analyzer to analyze an error in each of the encoded HD signal and the encoded SD signal;
a selector to select a signal having a highest displayable definition by identifying the error in each of the encoded HD signal and the encoded SD signal;
a decoder to decode the signal selected by the selector;
a despreader to despread and demodulate the satellite signal to extract an encoded low definition (LD) signal; and
a packetizer to packetize the encoded LD signal into Internet Protocol (IP) packets and to output the IP packets to an IP network.

9. The receiver of claim 8, wherein the HD corresponds to a high-level definition, the SD corresponds to a standard-level definition, and the LD corresponds to ¼ a value of the SD value.

10. The receiver of claim 7, further comprising:
a satellite antenna to receive the satellite signal; and
a downconverter to downconvert a frequency of the satellite signal and to provide the frequency-downconverted satellite signal to the demodulator and the despreader.

11. A method of transmitting satellite broadcasts in a satellite broadcasting system, the method comprising:
encoding a broadcast signal into a high definition (HD) signal;
encoding the broadcast signal into a standard definition (SD) signal;
encoding the broadcast signal into a low definition (LD) signal;
modulating each of the encoded HD signal and the encoded SD signal by a predetermined modulation scheme;
spreading a spectrum of the encoded LD signal to generate a spread spectrum signal and modulating the generated spread spectrum signal; and
combining the modulated spread spectrum signal with the modulated HD signal and the modulated SD signal to generate a combined modulated signal.

12. A method of receiving satellite broadcasts in a satellite broadcasting system, the method comprising:
demodulating a satellite signal to extract an encoded high definition (HD) signal and an encoded standard definition (SD) signal;
despreading and demodulating the satellite signal to extract an encoded low definition (LD) signal;
analyzing an error in each of the encoded HD signal, the encoded SD signal, and the encoded LD signal;
selecting a signal having a highest displayable definition by identifying the error in each of the encoded HD signal, the encoded SD signal, and the encoded LD signal; and
decoding the selected signal having the highest displayable definition.

13. A method of receiving satellite broadcasts in a satellite broadcasting system, the method comprising:
demodulating a satellite signal to extract an encoded high definition (HD) signal and an encoded standard definition (SD) signal;
analyzing an error in each of the encoded HD signal and the encoded SD signal;
selecting a signal having a highest displayable definition by identifying the error in each of the encoded HD signal and the encoded SD signal;
decoding the selected signal having the highest displayable definition;
despreading and demodulating the satellite signal to extract an encoded low definition (LD) signal; and
packetizing the encoded LD signal into Internet Protocol (IP) packets and outputting the IP packets to an IP network.
